(19) United States
(12) Patent Application Publication
(10) Pub. No.: US 2025/0333236 A1
(43) Pub. Date: Oct. 30, 2025

(54) CAPSULE, WATER DISTRIBUTION WALL FOR SUCH A CAPSULE, AND METHOD FOR MANUFACTURING SUCH A CAPSULE

(71) Applicant: Société des Produits Nestlé S.A., Vevey (CH)

(72) Inventors: Violette Bourg, Divonne Les Bains (FR); Pascal Girardin, Grandvaux (CH)

(73) Assignee: Société des Produits Nestlé S.A., Vevey (CH)

(21) Appl. No.: 18/868,698

(22) PCT Filed: Jul. 3, 2023
(86) PCT No.: PCT/EP2023/068176

§ 371 Date: Nov. 22, 2024

(30) Foreign Application Priority Data
Jul. 5, 2022 (EP) 22183031.8

(51) Int. Cl. B65D 85/804; A47J 31/36; B32B 1/00; B32B 23/08

(52) U.S. Cl. CPC B65D 85/8043; A47J 31/3695; B32B 1/00; B32B 23/08; B32B 2250/05; B32B 2307/7163; B32B 2307/7242; B32B 2307/7265; B32B 2439/70

(57) ABSTRACT

The present invention concerns a capsule (1) comprises a cup-shaped capsule body (2), a water distribution wall (10) delimiting a chamber (12) for a substance, and a bottom wall (14). The cup-shaped capsule body (2) comprises: a cellulose-based body layer (18) and a liner (20) comprising a liner barrier layer (22). The water distribution wall (10) and/or the bottom wall (14) comprises a wall barrier layer (32). The water distribution wall (10) and/or the bottom wall (14) is/are connected to the cup-shaped capsule body (2) such that the liner barrier layer (22) and the respective wall barrier layer (32) are united along a circumference of the body (2).

### FIELD OF THE INVENTION

The present invention is directed to a capsule for producing a beverage in a beverage production machine. The invention is further directed to a water distribution wall for being connected to a cup-shaped capsule body of a capsule to delimit a chamber within a cavity delimited by the body for containing a substance for the production of a beverage by injecting a fluid. The present invention is also directed to a method for manufacturing such a capsule.

### TECHNICAL BACKGROUND

EP 1784344 A2, the content of which is herein incorporated by reference, discloses a capsule comprising: i) a cup-shaped capsule body, ii) a water distribution wall delimiting with the body a cavity for containing a food substance, and iii) a bottom wall which gets opened by fluid pressure to let the beverage flow out of the capsule.

The cup-shaped capsule body comprises i) a body layer, ii) a barrier layer fastened to the body layer and preventing ingress of moisture and/or gas like oxygen into the cavity to preserve the food substance, and iii) a protection layer intended in particular for protecting the barrier layer from e.g. scratching or wearing.

The barrier layer and the protection layer can be formed into a capsule by thermoforming onto the body layer. As a result, the protection layer might become very thin. When assembling the capsule, the water distribution wall is sealed on the body, for example by ultrasonic welding, which involves a certain pressure and/or heat transmitted by an edge region of the water distribution wall onto the protection layer.

However, due to this pressure and/or heat, the water distribution wall might happen to locally create a barrier disruption into the protection layer and the barrier layer, thus letting moisture or gas enter the capsule and degrade the quality of the food substance.

### SUMMARY

It is thus an object of the present invention to provide a capsule showing an enhanced resistance to its manufacturing method, in order to ensure a reliable sealing of the water distribution wall on the cup-shaped capsule body, that does not negatively impact the gas and/or moisture barrier properties of the capsule. According to an aspect, the present invention is directed to a capsule for producing a beverage in a beverage production machine by injecting a fluid under pressure in said capsule, wherein the capsule comprises:
a cup-shaped capsule body with a cavity, a top opening and a bottom opening, the top opening and the bottom opening being located at substantially opposite sides of the cup-shaped capsule body with respect to the cavity,
a water distribution wall connected to the cup-shaped capsule body to delimit a chamber within the cavity, the water distribution wall being configured to allow passage of the fluid, the chamber being configured for containing a substance for the production of the beverage,
a top wall for closing the top opening, and
a bottom wall for closing the bottom opening, said bottom wall being adapted to be opened when pressure increases inside the capsule, in order to allow the beverage produced in the chamber to flow out of the capsule,
wherein the cup-shaped capsule body has a layered structure comprising:
a body layer moulded out of cellulose-based material, and
a liner applied on an inner face of the body layer,
wherein the liner comprises a liner barrier layer configured to provide a moisture and/or gas barrier function,
wherein the water distribution wall and/or the bottom wall respectively comprise(s) a wall barrier layer configured to provide a moisture and/or gas barrier function, and
wherein the water distribution wall and/or the bottom wall is/are connected to the cup-shaped capsule body such that the liner barrier layer and the respective wall barrier layer are united along a circumference of the body.

Thus, as the liner barrier layer and the wall barrier layer are united, they are melted and thus form a sealing zone that can be suitably tight to moisture and/or gas, thus ensuring a reliable sealing of the water distribution wall on the cup- shaped capsule body.

In the present disclosure, the relative terms “bottom” and “top” may relate to the orientation of the capsule when a food or beverage substance, e.g. ground coffee, is placed in the cavity and retained, against the action of gravity, by a bottom part of the capsule, for example the bottom wall.

In various implementations, in order to allow passage of the fluid, the water distribution wall may have one or more slit(s) or hole(s), which may be punctured or perforated through the water distribution wall.

In various implementations:
the substance may be selected within the list of: roast and ground coffee, soluble ingredients such as milk-based, chocolate, soups, infusion or herbal tea ingredients as well as nutritional soluble compositions, and more generally any liquid edible composition for human or animal consumption, and/or mixtures thereof, and/or
the substance may be provided in the chamber as a substance bed, and/or
the substance, preferably the substance bed, may be retained in the chamber, preferably in compression, by the water distribution wall and preferably between the water distribution wall and the bottom wall.

In the present disclosure, the term “moisture and/or gas barrier function” may be understood as involving:
an OTR (oxygen transmission rate) less than 5 cm³/m²/day, preferably less than 1 cm³/m²/day (at 23° C. and 50% of Relative Humidity); and
a WVTR (water vapor transmission) rate less than 5 g/m²/day, preferably less than 1 g/m²/day (at 23° C. and 85% of Relative Humidity).

According to an embodiment, the liner may have a multi-layered structure comprising, in addition to the liner barrier layer:
an outer liner layer covering the liner barrier layer at a side of the body layer, and/or
an inner liner layer covering the liner barrier layer at a side of the cavity.

Thus, the liner barrier layer located between the inner and outer liner layers can be protected from mechanical, thermal and/or chemical stresses.

In an alternative implementation, the liner may consist in the liner barrier layer alone, and a coating may be applied on the body layer to enhance tightness to external moisture and/or gas.

According to an embodiment, the outer liner layer may be arranged between the body layer and the liner barrier layer, for applying the liner to the body layer.

Thus, the liner may be applied onto the body layer.

According to an embodiment, an outer joining layer may be arranged to join the liner barrier layer and the outer liner layer, and an inner joining layer may be arranged to join the liner barrier layer and the inner liner layer.

Thus, the liner barrier layer can be reliably joined or fastened to the outer liner layer on the one hand and to the inner liner layer on the other hand.

According to an embodiment, the water distribution wall and/or the bottom wall may have, respectively, a multi-layered structure comprising, in addition to the wall barrier layer:
a main layer, and/or
at least one protection layer covering a face of the wall barrier layer, and preferably another protection layer covering an opposite face of the wall barrier layer.

Thus, the wall barrier layer covered by the protection layer(s) can be protected from mechanical, thermal and/or chemical stresses.

In an alternative implementation, the water distribution wall may consist in the wall barrier layer alone, wherein, preferably, the wall barrier layer consists in or comprises Polyhydroxyalkanoates (PHA).

According to an embodiment, the water distribution wall and/or the bottom wall may be connected to the body such that the inner liner layer and the at least one protection layer may be sealed to each other along said circumference so that the liner barrier layer and the wall barrier layer are united along said circumference.

In various implementations, when the water distribution wall has more than one layer, the water distribution wall may be made by co-extrusion, preferably by cast or blown extrusion of its layers.

Thus, a circumferential region where the liner barrier layer and the wall barrier layer are united can present an enhanced tightness to moisture and/or gas.

According to an embodiment, one of the protection layers may be arranged between the main layer and the wall barrier layer, for connecting the wall barrier layer to the main layer.

Thus, the wall barrier layer to the main layer can be firmly connected and protected by such protection layer.

According to an embodiment, a wall joining layer may be arranged to join the wall barrier layer and one of the protection layers, and/or
a main joining layer may be arranged to join the wall barrier layer and the main layer, preferably arranged to join the wall barrier layer and one of the protection layers.

Thus, the wall barrier layer can be reliably joined to the main layer, preferably via the protection layer.

In various implementations:
the liner may have a maximum thickness ranging from 30 to 140 microns (μm), and/or
the water distribution wall and/or the bottom wall may have a maximum thickness ranging from 10 to 150 microns, preferably from 50 to 80 microns, and/or
the liner barrier layer and/or the wall barrier layer may respectively have a maximum thickness ranging from 1 to 10 microns, preferably from 4 to 8 microns, and/or
the outer liner layer and/or the inner liner layer, if present, may respectively have a maximum thickness ranging from 10 to 30 microns, preferably from 15 to 20 microns, and/or
the protection layer(s), if present, may have a maximum thickness ranging from 10 to 30 microns, preferably from 15 to 20 microns, and/or
the main layer may have a maximum thickness ranging from 10 to 50 microns, preferably from 20 to 30 microns, and/or
preferably the inner and outer joining layers, if present, may respectively have a maximum thickness of about 5 microns, or a maximum thickness of about 4 microns, or a thickness between 1 to 4 microns, and/or
preferably the wall and main joining layers, if present, may respectively have a maximum thickness of about 5 microns, or a maximum thickness of about 4 microns, or a thickness between 1 to 4 microns.

Such thicknesses can allow the various layers to be resistant thermally, mechanically and/or chemically, while achieving a relatively short composting duration under home conditions.

According to an embodiment, the chamber may be defined between the bottom wall and the water distribution wall.

Thus, the chamber may be relatively large, the fluid may easily be brought into the chamber, and the produced beverage may easily be dispensed of the chamber.

In various implementations, the liner may be applied on the body layer by way of thermoforming.

Thus, the inner liner can be reliably fastened onto the body layer.

According to an embodiment, the water distribution wall may comprise a punctured wall section configured to break a jet of the injected fluid to reduce a speed of the fluid injected into the cavity, the punctured wall section being preferably configured to distribute the fluid over and preferably across the chamber at a reduced speed.

Thus, the fluid can be distributed smoothly into the whole chamber, thus enhancing the beverage quality.

According to an embodiment, the capsule may further comprise a rim portion arranged at the top opening so as to protrude laterally away from the top opening, the rim portion preferably being integral with the cup-shaped capsule body, wherein the liner extends over the rim portion in a circumferentially closed manner, and preferably, the top wall may be sealed to the rim portion so as to close the top opening.

Thus, the cavity can be closed reliably by the top wall.

According to an embodiment, the cup-shaped capsule body may comprise a stepped portion facing towards the top opening, and the bottom wall may be connected to the stepped portion, preferably along said circumference of the cup- shaped capsule body.

Thus, the stepped portion can allow to fasten the bottom wall.

According to an embodiment, a head space may be delimited within the cavity between the water distribution wall and the top opening, and/or
wherein a dispensing space may be delimited within the cup- shaped capsule body at a side opposite to the bottom wall with respect to the cavity, the dispensing space housing an opening device,
the opening device and the bottom wall being provided with respect to each other such that engagement between the bottom wall and the opening device is performed under the effect of pressure rising inside the capsule or chamber to open the bottom wall for allowing the beverage produced in the chamber to flow out of the capsule.

Thus, the head space and dispensing can allow a beverage production machine to produce a beverage more easily and reliably.

In various implementations:
the water distribution wall may be made of a home-compostable material composition, and/or
the capsule may be made of a home-compostable material composition, and/or
the cellulose-based material may be or comprises moulded pulp material, and/or
the main layer may be made of a home-compostable material, and/or
the liner barrier layer and the wall barrier layer may be made of the same material, and/or are made of a home-compostable material, and/or
the inner liner layer, the outer liner layer, and/or preferably the protection layers, if present, may be made of the same material, and/or are made of a home-compostable material, and/or
preferably the outer joining layer, the inner joining layer, the wall joining layer, and/or the main joining layer, if present, may be made of the same material, and/or are made of a home-compostable material.

The term “compostable” may be understood as meaning that a material may be substantially broken down into organic matter within a few weeks or months when it is composted. This may be accomplished in industrial composting sites and/or home composters. Specific conditions relating to wind, sunlight, drainage and other factors may exist at such sites. At the end of a composting process, the earth maybe supplied with nutrients once the material has completely broken down. International standards, such as EU 13432 or US ASTM D6400, provide a legal framework for specifying technical requirements and procedures for determining compostability of a material. For example, one of the tests for compostability requires that-in order to be considered “industrially compostable”—at least 90% of the material in question is to be biologically degraded under controlled conditions within 6 months. Similar tests exist for home composting certification. Furthermore, according to the mentioned standards, compostable plastic materials must have the following characteristics simultaneously to be considered compostable: the material must be biodegradable and disintegrable, i.e. fragmentation and invisibility in the final compost, and it must not have negative effects on the composting process and quality.

Preferably, the home-compostable material composition may be selected within the list of: polybutylene succinate (PBS), polybutylene adipate (PBA), starch, polycaprolactone (PCL), polybutylene terephthalate (PBT), polylactic acid (PLA), blends and copolymers of thereof but preferably made of cellulose and derivatives, chitin and derivatives, Polyhydroxyalkanoates (PHAs) and/or Polyglycolic acid (PGA), and/or blends and/or copolymers of these polymers, and mixtures thereof.

Thus, such materials may be composted at home by the users themselves without requiring any particular conditions for the composting.

It is also a further object of the present invention to provide a water distribution wall for enhancing the reliability of its sealing with a cup-shaped capsule body when manufacturing the capsule.

Accordingly, a further aspect of the present invention is directed to a water distribution wall for being connected to a cup-shaped capsule body of a capsule to delimit a chamber within a cavity located in the cup-shaped capsule body for containing a substance for the production of a beverage by injecting a fluid,
wherein the water distribution wall comprises a punctured wall section configured to break a jet of the injected fluid to reduce a speed of the fluid injected into the cavity, and preferably distribute the fluid over and preferably across the chamber at a reduced speed,
wherein the water distribution wall has a mono-layered or a multi- layered structure comprising at least a wall barrier layer configured to provide a moisture and/or gas barrier function.

Thus, such a water distribution wall ensures a reliable sealing of the water distribution wall on the cup-shaped capsule body, while not impacting negatively the gas and/or moisture barrier properties of the capsule.

It is a further object of the present invention to provide a method for manufacturing a capsule according to the above-detailed aspect.

Accordingly, a further aspect of the present invention is directed to a method for manufacturing a capsule according to any one of the above-mentioned embodiments and implementations, the method comprising:
providing the cup-shaped capsule body, the top wall, the bottom wall, and the water distribution wall,
connecting the bottom wall to the cup-shaped capsule body, preferably by ultrasonic welding or heat sealing, to close the bottom opening,
placing a substance for the production of the beverage in the cavity,
connecting the water distribution wall to the cup-shaped capsule body, preferably by ultrasonic welding or heat sealing, to delimit the chamber containing the substance together with the cup-shaped capsule body and the bottom wall, and
preferably, connecting the top wall to the body, preferably by ultrasonic welding or heat sealing, to close the top opening,
wherein the water distribution wall and/or the bottom wall is/are connected to the body such that the liner barrier layer and the wall barrier layer are united along a circumference of the body.

Thus, such a method enables to manufacture a capsule that ensures a reliable sealing of the water distribution wall on the cup-shaped capsule body, without negatively impacting the gas and/or moisture barrier properties of the capsule.

### BRIEF DESCRIPTION OF DRAWINGS

Further features, details and advantages of the present invention are described hereinafter, in particular in relation to the embodiments illustrated in the appended figures, in which:

FIG. 1 shows a schematic partial cutaway perspective view of a capsule according to the present invention with a cross-section through the cup- shaped capsule body and bottom wall;

FIG. 2 shows an enlarged view of detail II in FIG. 1;

FIG. 3 shows a schematic perspective view of various layers, in a merely illustrative semi-loose state, of a liner for the cup-shaped capsule body of the capsule of FIGS. 1-2;

FIG. 4 shows a schematic perspective view of various layers, in a merely illustrative semi-loose state, of a water distribution wall of the capsule of FIGS. 1-2;

FIG. 5 shows a schematic cross-section along plane V in FIG. 1;

FIG. 6 shows a flowchart of a method according to the present invention for manufacturing the capsule of FIG. 1.

### DETAILED DESCRIPTION

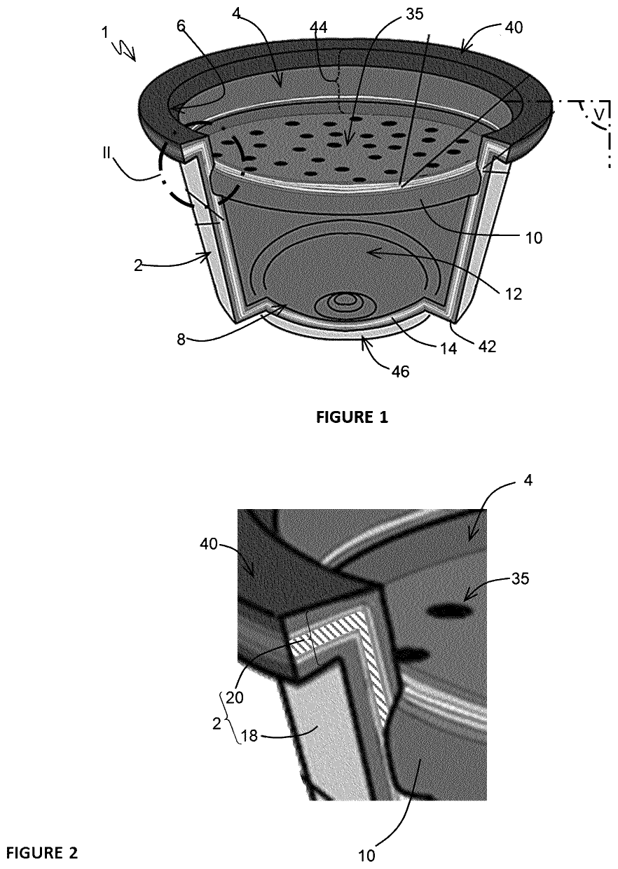

FIGS. 1 and 2 show a capsule 1 for producing a beverage in a not-shown beverage production machine. The beverage production machine may inject a fluid, e.g. water, under pressure in the capsule 1 and the beverage produced in the capsule 1 may flow out of the capsule toward a not-shown drinking cup.

The capsule 1 comprises a cup-shaped capsule body 2 with a cavity 4, a top opening 6 and a bottom opening 8. The top opening 6 and the bottom opening 8 are located at substantially opposite sides of the cup-shaped capsule body 2 with respect to the cavity 4. In the example of FIGS. 1 to 5, the cup-shaped capsule body 2 may substantially have a frustoconical shape, for example generated on a circular basis.

The capsule 1 further comprises a water distribution wall 10, which is connected to the cup-shaped capsule body 2 to delimit or comprise a chamber 12 within the cavity 8. The water distribution wall 10 is configured to allow passage of the fluid. The chamber 12 is configured for containing a not-shown substance for the production of the beverage. The substance may for example be roast and ground coffee. The substance may be provided in the chamber 12 as a substance bed.

The capsule 1 further comprises a top wall for closing the top opening 8, and a bottom wall 14 closing the bottom opening 8. In the embodiment of FIGS. 1 to 5, the chamber 12 may be defined between the bottom wall 14 and the water distribution wall 6. Preferably, the substance or substance bed may be retained, preferably in compression, in the chamber 12 between the water distribution wall 10 and the bottom wall 14.

The bottom wall 14 is adapted to be opened when pressure increases inside the capsule 1, in particular inside the chamber 12. For example, the opening pressure may be within the range of 1 to 15 bar (relative pressure), and usually within the range of 4 to 15 bar for roast and ground coffee, and lower opening pressures (1-2 bar) for soluble ingredients. Once opened, the bottom wall 14 can allow the beverage produced in the chamber 12 to flow out of the capsule 1 through the bottom opening 8.

The cup-shaped capsule body 2, as depicted in FIGS. 2, 3 and 5, has a layered structure comprising i) a body layer 18 and a liner 20. The body layer 18 may provide stiffness to the body 2. The liner 20 may separate the cavity 4 from the body layer 18. The liner 20 is applied on an inner face of the body layer 18, for example without any intermediate layer there between. Nevertheless, in further embodiments, the liner may be applied on the inner face of the body layer via at least one intermediate layer. The liner 20 may for example be applied on the inner face of the body layer 18 by way of thermoforming.

An “inner” part is generally arranged more inside than an “outer” part by reference to e.g. the cavity that forms the interior of the capsule. Nevertheless, an “inner” part or layer is not necessarily the innermost part or layer of the capsule, and an “outer” part or layer is not necessarily the outermost part or layer of the capsule. Likewise, bottom or top parts are not necessarily the bottommost or topmost parts, respectively, of the capsule.

The body layer 18 is moulded out of cellulose-based material, which may be or comprise moulded pulp material, which may be selected within the list of: mechanical pulp, recycled paper pulp, bagasse pulp, annual plant pulp, virgin cellulose pulp, refined cellulose pulp, and/or mixtures thereof.

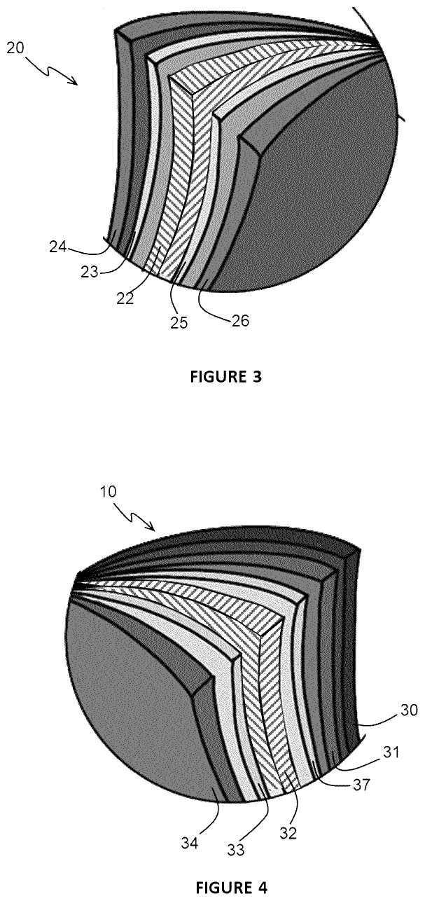

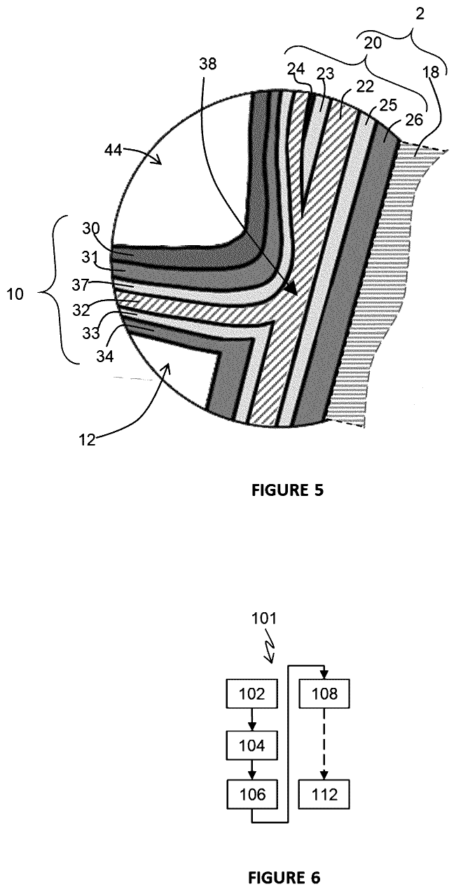

The capsule 1 may be made of a home-compostable material composition, including for example Polybutylene succinate (PBS) and/or Polyhydroxyalkanoate (PHAs).
The liner 20, as shown in FIGS. 3 and 5, comprises a liner barrier layer 22 configured to provide a moisture and/or gas (e.g. oxygen) barrier function. The liner 20 may have a multi-layered structure comprising, in addition to the liner barrier layer 22: an outer liner layer 26 covering the liner barrier layer 22 at a side of the body layer 18, and.
an inner liner layer 24 covering the liner barrier layer 22 at a side of the cavity 4.

The outer liner layer 26 may be arranged between the body layer 18 and the liner barrier layer 22, for applying the liner 20 to the body layer 18.

The liner 20 may further comprise an inner joining layer 23 and an outer joining layer 25. The inner joining layer 23 may be arranged to join the liner barrier layer 22 and the inner liner layer 24. The outer joining layer 25 may be arranged to join the liner barrier layer 22 and the outer liner layer 26. The outer joining layers 23 and 25 may be formed of a gluing or sticking film.

The liner 20 may thus have a symmetrical structure of layers. The liner 20 may have a maximum thickness of about 80 microns. The liner barrier layer 22 may have a maximum thickness of about 8 microns. The body joining layers 23, 25 may respectively have a maximum thickness of about 4 microns.

The water distribution wall 10 comprises a wall barrier layer 32, which is configured to provide a moisture and/or gas barrier function. The water distribution wall 10 may have a multi-layered structure comprising, in addition to the wall barrier layer 32:
a main layer 30, which may provide stiffness to the water distribution wall 10, and
two protection layers 31 and 34, which respectively cover both faces, i.e. one face and the opposite face, of the wall barrier layer 32.

One of the protection layers, herein 31, may be arranged between the main layer 30 and the wall barrier layer 32, for connecting the wall barrier layer 32 to the main layer 30. The other one of the protection layers, herein 34, may be left uncovered.

The water distribution wall 10 may further comprise a wall joining layer 33 and a main joining layer 37. The wall joining layer 33 may be arranged to join the wall barrier layer 32 and the protection layer 34. The main joining layer 37 may be arranged to join the wall barrier layer 32 and the main layer 30, preferably arranged to join the wall barrier layer 32 and the protection layer 31.

The water distribution wall 10 may have a maximum thickness of about 40 microns. The main layer 30 may have a maximum thickness of about 25 microns. The protection layers 31 and 34 may respectively have a maximum thickness of about 20 microns. The various joining layers 33 and 37 may respectively have a maximum thickness of about 4 microns.

The water distribution wall 10 may comprise a punctured wall section 35 configured to break a jet of the injected fluid to reduce a speed of the fluid injected into the cavity 4. Preferably, the punctured wall section 35 may be configured to distribute the fluid over and preferably across the chamber 12 at a reduced speed.

In an embodiment (not illustrated in the drawing), the bottom wall 14 comprises a wall barrier layer, which is configured to provide a moisture and/or gas barrier function. Further, the bottom wall 14 may have a multi-layered structure, which is similar or identical to the one of the water distribution wall 10, that is, comprising the wall barrier layer, a main layer, and preferably one or two protection layers covering one or both face(s) of the wall barrier layer.

According to the present invention, as illustrated in FIG. 5, the water distribution wall 10 is connected to the cup-shaped capsule body 2 such that the liner barrier layer 22 and the wall barrier layer 32 are united along a circumference of the body 2. In the example of FIGS. 1 to 5, the water distribution wall 10 may be connected to the body 2 such that the inner liner layer 24 and the protection layers 34 and 31 are sealed to each other along said circumference, so that the liner barrier layer 22 and the wall barrier layer 32 are united along said circumference.

The circumference, as visible in FIG. 1 or 5, may be oriented inwards and extend along the cavity 4. For example, the circumference may substantially have the shape of a circle or ring. The liner barrier layer 22 and the wall barrier layer 32 may be united either or both i) by a physical connection, i.e. simply pushed one against the other, and/or ii) by any material connection, i.e. welded or glued together.

During the sealing of the water distribution wall 10 on the liner 20, the inner liner layer 24 can melt and, under the effect of sealing (i.e. of thermal and mechanical stresses), be pushed away from the sealing zone 38. After the inner liner layer 24 has been pushed away, the liner barrier layer 22 is left uncovered.

The water distribution wall 10 together with its the wall barrier layer 32 can be pushed against the uncovered liner 20. As a result, the barrier disruption created by the removal of the inner liner layer 24 can be filled in by the wall barrier layer 32. This recreates a continuity of matter between the liner barrier layer 22 and the wall barrier layer 32, which makes the sealing zone 38 tight to moisture and/or gas.

Alternatively or additionally, according to the present invention, in a not shown embodiment, the bottom wall 14 is connected to the cup-shaped capsule body 2 such that the liner barrier layer 22 and the wall barrier layer of the bottom wall 14 are united along a circumference of the body 2.

The capsule 1 may further comprise a rim portion 40, as shown in FIGS. 1 and 2, which may be arranged at the top opening 6 so as to protrude laterally away from the top opening 6. The rim portion 40 may be integral with the cup-shaped capsule body 2. The liner 20 may extend over the rim portion 40 in a circumferentially closed manner. The not shown top wall may be sealed to the rim portion 40 so as to close the top opening 6.

The cup-shaped capsule body 2 may comprise a stepped portion 42 facing towards the top opening 6. The bottom wall 14 may be connected to the stepped portion 42, preferably along said circumference of the cup-shaped capsule body 2.

A head space 44 may be delimited within the cavity 4 between the water distribution wall 10 and the top opening 6. Similarly, a dispensing space 46 may be delimited within the cup-shaped capsule body 2 at a side opposite to the bottom wall 14 with respect to the cavity 4.

An opening device (not illustrated), like the one described in EP1784344A2, may be housed in the dispensing space 46. The opening device and the bottom wall 14 may be provided with respect to each other such that engagement between the bottom wall 14 and the opening device may be performed under the effect of pressure rising inside the capsule 1 or chamber 12 to open the bottom wall 14 for allowing the beverage produced in the chamber 12 to flow out of the capsule 1.

Home-compostable materials may compose the capsule 1 as previously indicated. In particular, the water distribution wall 14, the main layer 30, the liner barrier layer 22, the inner liner layer 24, the outer liner layer 26, the inner joining layer 23, the outer joining layer 25, the wall barrier layer 32, the protection layers 31 and 34, the wall joining layer 33, and the main joining layer 37 may be made out of home-compostable materials.

According to a further aspect of the present invention, the water distribution wall 10 may be provided, as a stand-alone component, for being connected to the cup-shaped capsule body 2 of the capsule 10 to delimit the chamber 12 within the cavity 4. The cavity 4 is located in the cup-shaped capsule body 2. The cavity 4 is configured for containing the substance for the production of a beverage by injecting the fluid. The water distribution wall 10 has a mono-layered or a multi-layered structure as afore-detailed.

The water distribution wall 10 comprises a punctured wall section 35, which is configured to break a jet of the injected fluid to reduce a speed of the fluid injected into the cavity 4, and preferably distribute the fluid over and preferably across the chamber 12 at a reduced speed.

According to another aspect of the present invention, as shown in FIG. 6, a method 101, for manufacturing the capsule 1, comprises:
step 102) providing the cup-shaped capsule body 2, the top wall, the bottom wall 14, and the water distribution wall 10,
step 104) connecting the bottom wall 14 to the cup-shaped capsule body 2, preferably by ultrasonic welding or heat sealing, to close the bottom opening 8,
step 106) placing a substance, for example roast and ground coffee, for the production of the beverage in the cavity 4,
step 108) connecting the water distribution wall 10 to the cup-shaped capsule body 2, preferably by ultrasonic welding or heat sealing, to delimit the chamber 12 containing the substance together with the cup-shaped capsule body 2 and the bottom wall 14, and
step 110) preferably, connecting the top wall to the cup-shaped capsule body 2, preferably by ultrasonic welding or heat sealing, to close the top opening and thus the cavity 4.

Then, the water distribution wall 10 is connected to the cup-shaped capsule body 2 such that the liner barrier layer 22 and the wall barrier layer 32 of water distribution wall 10 are united along said circumference.

Likewise, in a not-shown embodiment, the bottom wall 14 is connected to the cup-shaped capsule body 2 such that the liner barrier layer 22 and the wall barrier layer of bottom wall 14 are united along said circumference.

The words “comprise”, “include”, “have” and their derivatives are to be interpreted inclusively rather than exclusively. The term “and/or” used in the context of “X and/or Y” should be interpreted as “X,” or “Y,” or “X and Y.”

The present invention is not limited to the afore-described aspects and embodiments, as long as the present invention remains covered by the appended claims.

1. A capsule for producing a beverage in a beverage production machine by injecting a fluid under pressure in said capsule, wherein the capsule comprises:
a cup-shaped capsule body with a cavity, a top opening and a bottom opening, the top opening and the bottom opening being located at substantially opposite sides of the cup-shaped capsule body with respect to the cavity,
a water distribution wall connected to the cup-shaped capsule body to delimit a chamber within the cavity, the water distribution wall being configured to allow passage of the fluid, the chamber being configured for containing a substance for the production of the beverage,
a top wall for closing the top opening, and
a bottom wall for closing the bottom opening, said bottom wall being adapted to be opened when pressure increases inside the capsule, in order to allow the beverage produced in the chamber to flow out of the capsule,
wherein the cup-shaped capsule body has a layered structure comprising:
a body layer moulded out of cellulose-based material, and
a liner applied on an inner face of the body layer,
wherein the liner comprises a liner barrier layer configured to provide a moisture and/or gas barrier function,
wherein the water distribution wall and/or the bottom wall respectively comprise(s) a wall barrier layer configured to provide a moisture and/or gas barrier function, and
wherein the water distribution wall and/or the bottom wall is/are connected to the cup-shaped capsule body such that the liner barrier layer and the respective wall barrier layer are united along a circumference of the body.

2. The capsule according to claim 1, wherein the liner has a multi-layered structure comprising, in addition to the liner barrier layer:
an outer liner layer covering the liner barrier layer at a side of the body layer, and/or
an inner liner layer covering the liner barrier layer at a side of the cavity.

3. The capsule according to claim 2, wherein the outer liner layer is arranged between the body layer and the liner barrier layer, for applying the liner to the body layer.

4. The capsule according to claim 2,
wherein an outer joining layer is arranged to join the liner barrier layer and the outer liner layer, and
wherein an inner joining layer is arranged to join the liner barrier layer and the inner liner layer.

5. The capsule according to claim 1,
wherein the water distribution wall and/or the bottom wall has/have, respectively, a multi-layered structure comprising, in addition to the wall barrier layer:
a main layer, and/or
at least one protection layer covering a face of the wall barrier layer and another protection layer covering an opposite face of the wall barrier layer.

6. The capsule according to claim 2, wherein the water distribution wall and/or the bottom wall is/are connected to the body such that the inner liner layer and the at least one protection layer are sealed to each other along said circumference so that the liner barrier layer and the wall barrier layer are united along said circumference.

7. The capsule according to claim 5, wherein one of the protection layers is arranged between the main layer and the wall barrier layer, for connecting the wall barrier layer to the main layer.

8. The capsule according to claim 5,
wherein a wall joining layer is arranged to join the wall barrier layer and one of the protection layers, and/or
wherein a main joining layer is arranged to join the wall barrier layer and the main layer arranged to join the wall barrier layer and one of the protection layers.

9. The capsule according to claim 1, wherein the chamber is defined between the bottom wall and the water distribution wall.

10. The capsule according to claim 1, wherein the water distribution wall comprises a punctured wall section configured to break a jet of the injected fluid to reduce a speed of the fluid injected into the cavity, the punctured wall section being configured to distribute the fluid over and across the chamber at a reduced speed.

11. The capsule according to claim 1, further comprising a rim portion arranged at the top opening so as to protrude laterally away from the top opening, the rim portion preferably being integral with the cup-shaped capsule body,
wherein the liner extends over the rim portion in a circumferentially closed manner, and
wherein the top wall is sealed to the rim portion so as to close the top opening.

12. The capsule according to claim 1, wherein the cup-shaped capsule body comprises a stepped portion facing towards the top opening, and wherein the bottom wall is connected to the stepped portion along said circumference of the cup-shaped capsule body.

13. The capsule according to claim 1,
wherein a head space is delimited within the cavity between the water distribution wall and the top opening, and/or
wherein a dispensing space is delimited within the cup-shaped capsule body at a side opposite to the bottom wall with respect to the cavity, the dispensing space housing an opening device,
the opening device and the bottom wall being provided with respect to each other such that engagement between the bottom wall and the opening device is performed under the effect of pressure rising inside the capsule or chamber to open the bottom wall for allowing the beverage produced in the chamber to flow out of the capsule.

14. A water distribution wall for being connected to a cup-shaped capsule body of a capsule to delimit a chamber within a cavity located in the cup-shaped capsule body for containing a substance for the production of a beverage by injecting a fluid,
wherein the water distribution wall comprises a punctured wall section configured to break a jet of the injected fluid to reduce a speed of the fluid injected into the cavity, and distribute the fluid over and across the chamber at a reduced speed,
wherein the water distribution wall has a mono-layered or a multi-layered structure comprising at least a wall barrier layer configured to provide a moisture and/or gas barrier function.

15. A method for manufacturing a capsule according to claim 1, comprising:
providing the cup-shaped capsule body, the top wall, the bottom wall, and the water distribution wall,
connecting the bottom wall to the cup-shaped capsule body by ultrasonic welding or heat sealing, to close the bottom opening,
placing a substance for the production of the beverage in the cavity,
connecting the water distribution wall to the cup-shaped capsule body, by ultrasonic welding or heat sealing, to delimit the chamber containing the substance together with the cup-shaped capsule body and the bottom wall, and
connecting the top wall to the body by ultrasonic welding or heat sealing, to close the top opening,
wherein the water distribution wall and/or the bottom wall is/are connected to the body such that the liner barrier layer and the wall barrier layer are united along a circumference of the body.
